(19) United States
(12) Patent Application Publication
(10) Pub. No.: US 2026/0153612 A1
(43) Pub. Date: Jun. 4, 2026

(54) METHOD AND APPARATUS FOR INTERACTION SENSING

(71) Applicant: Nokia Technologies Oy, Espoo (FI)

(72) Inventors: Xiaobing LENG, Shanghai (CN); Nan HU, Shanghai (CN); Pengfei GUI, Shanghai (CN); Gabor SOROS, Budapest (HU)

(21) Appl. No.: 19/122,968

(22) PCT Filed: Oct. 24, 2022
(86) PCT No.: PCT/CN2022/127099

§ 371 Date: Apr. 21, 2025

(51) Int. Cl. G01S 13/34; G01S 13/42; G01S 13/86

(52) U.S. Cl. CPC G01S 13/584; G01S 7/006; G01S 13/10

(57) ABSTRACT

Methods and apparatus are disclosed for interaction sensing in an integrated sensing and communication (ISAC) system. A method performed at the mobile communication device which is carried on an object, comprises, receiving configuration information of a sensing radar; receiving a sensing radar signal from the sensing radar at least according to the configuration information; constructing a virtual radar signal for the received sensing radar at least based on the configuration information and a sensing time slot at which the sensing radar signal is received; estimating a distance and velocity of the mobile communication device, according to the virtual radar signal and the received sensing radar; and sending to a network node, an interaction sensing report indicating the estimated distance and velocity together with the sensing time slot, so that a matching relationship can be established between a radar-sensed object and the mobile communication device.

### TECHNICAL FIELD

Embodiments of the disclosure generally relate to integrated sensing and communication (ISAC), and more particularly, to methods and apparatus for utilizing interaction sensing to establish match relationship between a moving object and a mobile communication device carried by the moving object.

### BACKGROUND

Integrated sensing and communication (ISAC) may become a new function in future wireless networks. Some companies have submitted proposals to 3GPP about it. In the European 6G flagship project Hexa-X, a demo is designed to showcase the potential for ISAC allowing for abundant cost-effective sensing by re-using existing hardware and infrastructure.

Currently, most ISAC solutions are based on integrating radar sensing into a communication system. A sensing radar can scan its coverage scope to measure distances and velocities of moving objects, e.g., pedestrian, cyclist, vehicle, autopilot vehicle, automated guided vehicle (AGV), unmanned aerial vehicle (UAV), etc. In general, these moving objects always have some active communication device or module, e.g., user equipment (UE), mobile phone, tablet computer, portable android device (PAD), autopilot system with wireless communication ability, etc. While a sensing radar can sense those large moving objects, it can hardly sense those small communication devices. Furthermore, a sensing radar cannot uniquely identify those moving objects, i.e., it cannot know who those moving objects are. An on-board communication device can always have identification information of its owners (i.e., the moving object on which the communication device is carried).

For example, a sensing radar can sense some vehicles. But it cannot establish communication with an autopilot system of each vehicle, as it cannot distinguish them and cannot recognize them either. The autopilot system can be a UE device. If the system can establish a matching relationship between the vehicle and its autopilot system, a traffic control system will be easy to navigate those vehicles and avoid collision.

It is desired to establish a matching relationship between a moving object and its UE.

### SUMMARY

This summary is provided to introduce simplified concepts of the present disclosure. This summary is not intended to identify key features or essential features of the claimed subject matter, nor is it intended to be used to limit the scope of the claimed subject matter.

According to a first aspect of the disclosure, there is provided an apparatus at a mobile communication device carried on an object. The apparatus comprises at least one processor, and at least one memory storing instructions that, when executed on the at least one processor, cause the apparatus at least to receive configuration information of a sensing radar; receive a sensing radar signal from the sensing radar at least according to the configuration information; construct a virtual radar signal for the received sensing radar at least based on the configuration information and a sensing time slot at which the sensing radar signal is received; estimate a distance and a velocity of the mobile communication device, according to the virtual radar signal and the received sensing radar signal; and send to network node, an interaction sensing report indicating an estimated distance and velocity together with the sensing time slot.

According to a second aspect of the disclosure, there is provided an apparatus at a network node. The apparatus comprises at least one processor, and at least one memory storing instructions that, when executed on the at least one processor, cause the second apparatus at least to perform a first match between a mobile communication device and an object for at least one sensing time slot, by at least the following operations: receiving a first sensing report from a first radar, wherein the first sensing report indicates a first sensing time slot and the object sensed by the first radar together with a first distance and a first velocity of the object sensed in the first sensing time slot; receiving a first interaction sensing report from the mobile communication device, wherein the first interaction sensing report indicates a second sensing time slot and a first distance and a first velocity of the mobile communication device estimated in the second sensing time slot; and determining whether the mobile communication device matches with the object or not, according to the first interaction sensing report and the first sensing report; and associate the mobile communication device with the object, when it is determined that the mobile communication device matches with the object.

According to a third aspect of the disclosure, there is provided a method performed by a mobile communication device carried on an object. The method comprises: receiving configuration information of a sensing radar; receiving a sensing radar signal from the sensing radar at least based on the configuration information; constructing a virtual radar signal for the received sensing radar at least according to the configuration information and a sensing time slot at which the sensing radar signal is received; estimating a distance and velocity of the mobile communication device, according to the virtual radar signal and the received sensing radar; and sending to a network node, an interaction sensing report indicating the estimated distance and velocity together with the sensing time slot.

According to fourth aspect of the disclosure, there is provided a method performed by a network node. The method comprises: performing a first match between a mobile communication device and an object for at least one sensing time slot, by at least the following operations: receiving a first sensing report from a first radar, wherein the first sensing report indicates a first sensing time slot and the object sensed by the first radar together with a first distance and a first velocity of the object sensed in the first sensing time slot; determining whether the mobile communication device matches with the object or not, according to the first interaction sensing report and the first sensing report; and determining whether the mobile communication device matches with the object or not, according to the interaction sensing report and the sensing report; and associating the mobile communication device with the object, when it is determined that the mobile communication device matches with the object.

According to fifth aspect of the present disclosure, it is provided a computer readable storage medium, on which instructions are stored, when executed by at least one processor, the instructions cause the at least one processor to perform any method according to the third aspect and the fourth aspect.

According to sixth aspect of the present disclosure, it is provided computer program product comprising instructions which when executed by at least one processor, cause the at least one processor to perform any method according to the third aspect and the fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings in which:

FIG. 1 illustrates an exemplary interaction sensing system in which embodiments of the present disclosure can be implemented;

FIG. 2 illustrates another exemplary interaction sensing system in which embodiments of the present disclosure can be implemented;

FIG. 3 illustrates an exemplary scenario of interaction sensing and related signal processes, according to embodiments of the present disclosure;

FIG. 4 illustrates an exemplary procedure of interaction sensing operation, according to embodiments of the present disclosure;

FIG. 5 is a simplified block diagram of an exemplary component for sensing interaction that may be employed in a user equipment, according to an embodiment of the present disclosure;

FIG. 6 is a simplified block diagram of an exemplary component for interaction sensing that may be employed in a server, according to an embodiment of the present disclosure;

FIG. 7 is a flow chart depicting an exemplary discrimination procedure, according to an embodiment of the present disclosure;

FIG. 8 is a flow chart depicting a method according to an embodiment of the present disclosure;

FIG. 9 is a flow chart depicting a method according to an embodiment of the present disclosure; and

FIG. 10 shows a simplified block diagram of an apparatus according to an embodiment of the present disclosure.

### DETAILED DESCRIPTION

Some example embodiments will now be described in more detail hereinafter with reference to the accompanying drawings, in which some, but not all embodiments are shown. Indeed, the example embodiments may take many different forms and should not be construed as fixed to the embodiments set forth herein; rather, these embodiments are provided so that this disclosure will satisfy applicable legal requirements. Like reference numerals refer to like elements throughout.

In the following description and claims, unless defined otherwise, all technical and scientific terms used herein have the same meaning as commonly understood by one of ordinary skills in the art to which this disclosure belongs.

References in the present disclosure to “one embodiment”, “an embodiment”, “an example embodiment”, and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, the term “and/or” includes any and all combinations of one or more of the listed terms.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of “circuitry” applies to all uses of this term in this application, including in any claims. As a further example, as used in this application, the term “circuitry” also covers an implementation of merely a hardware circuit or processor (or multiple processors) or portion of a hardware circuit or processor and its (or their) accompanying software and/or firmware. The term “circuitry” also covers, for example and if applicable to the particular claim element, a baseband integrated circuit or processor integrated circuit for a mobile device or a similar integrated circuit in server, a cellular network device, or other computing or network device.

As used herein, the term “mobile communication device” refers to any device that can execute wireless communication, which may be a terminal device enabled to access a communication network and receive services therefrom via a wireless link. By way of example and not limitation, the terminal device may refer to a user equipment (UE), or other suitable devices. The terminal device may include, but not limited to, portable computers, image capture terminal devices such as digital cameras, gaming terminal devices, music storage and playback appliances, a mobile phone, a cellular phone, a smart phone, and a tablet, a wearable device, a personal digital assistant (PDA), an autopilot system of a vehicle with wireless communication ability, an Internet of things (IoT) device, a machine-to-machine (M2M) device, or apparatus (e.g., communication module, modem, or chip) in the forgoing devices, and the like.

As mentioned above, sensing radar can sense moving objects, but it cannot know who they are. Currently, six potential sensing solutions have been considered in the art of integrated sensing and communication:
BS_A→BS_A: a base station (BS) transmits a sensing radar signal and then receives an echo of the sensing radar signal;
BS_A→BS_B: a BS transmits a sensing radar signal and then another BS receives an echo of the sensing radar signal;
BS→UE: a BS transmits a sensing radar signal and then a UE receives an echo of the sensing radar signal;
UE_A→BS: a UE transmits a sensing radar signal and then a BS receives an echo of the sensing radar signal;
UE_A→UE_A: a UE transmits a sensing radar signal and then receives an echo of the sensing radar signal;
UE_A→UE_B: a UE transmits a sensing radar signal and then another UE receives an echo of the sensing radar signal.

That means both BS and UE may have sensing ability in the future. The present disclosure can be implemented based on the BS_A→BS_A method to sense mobile objects. Embodiments of the present disclosure further utilize a UE of a mobile object to sense radar sensing signals. This is referred to as an interaction sensing, i.e., UE senses BS sensing radar signals, and BS senses UE's owner (i.e., a mobile object carrying the UE). BS sensing radar senses moving objects based on echo signals of radar sensing signals reflected from the moving objects, and UE senses the direct signals from the radar received directly from the radar.

The present disclosure can be also implemented based on the UE_A→UE_A method. In these embodiments, a UE which transmits a sensing radar signal and receives echo of the sensing radar signal reflected from objects, acts as a sensing radar.

The present disclosure can provide new ISAC applications. For example, based on a result of interaction sensing, e.g., a sensing radar can recognize sensed mobile objects, a system can generate a moving object map and further provide the moving objects map to those recognized mobile objects, e.g., for optimizing navigation.

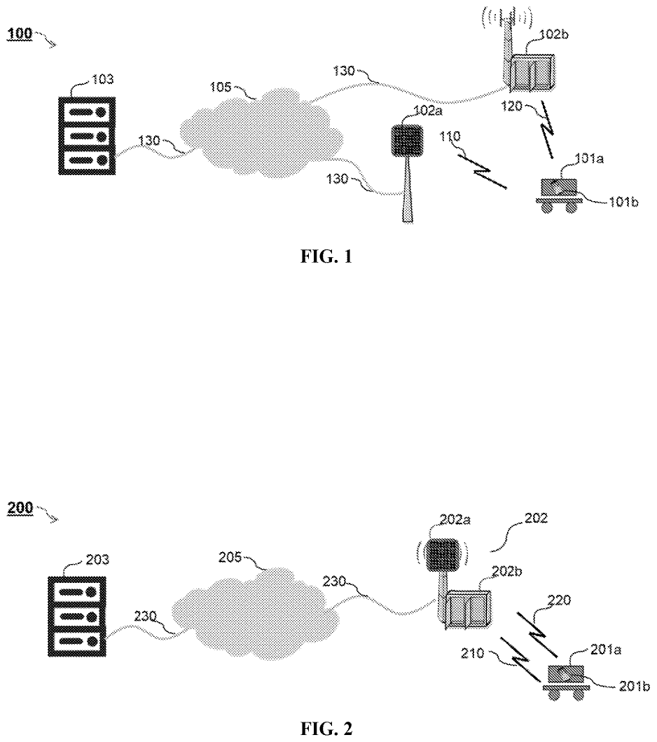

FIG. 1 illustrates an exemplary interaction sensing system 100 in which embodiments of the present disclosure can be implemented. The system 100 is an interaction sensing system with a standalone sensing radar. As shown in FIG. 1, the system 100 comprises a UE 101b which is carried on a movable object (e.g., an AGV) 101a, a sensing radar 102a, a base station 102b, and an interaction sensing server 103. The sensing radar 102a is deployed separately from a base station 102b, but can communicate with the base station, e.g., through a wired link 130. In some examples, a sensing radar 102a can communicate with the base station through a wireless link, e.g., a device-to-device (D2D) microwave link. For example, the sensing radar 102a can transmit sensing results to the base station 102b, and receive configuration information from the base station 102b. The sensing radar 102a may transmit sensing radar signals 110 to its surroundings, and receives corresponding echoes, so as to sense objects around it.

The UE 101b (such as a mobile phone, an autopilot module or other apparatus with wireless communication ability) can receive or detect sensing radar signals 110. The UE 101b can use a commutation radio receiver or an extra special receiver to receive sensing radar signals. Meanwhile, the UE 101b can further use the commutation radio receiver to communicate with the base station 102b, e.g., through a wireless link 120. Alternatively or additionally, the UE 101b may be configured to interface, access, or communicate with any other base stations, a radio network, a core network, or any other network.

The base station 102b may be known by other names in some implementations, such as a base transceiver station (BTS), a radio base station, a network node, a network device, a device on the network side, a transmit/receive node, a Node B, an evolved NodeB (eNodeB or eNB), a Home eNodeB, a next Generation NodeB (gNB), an access point (AP), and the like. The base station 102b may be in communication with a core network to provide the UE 101b with various services such as voice, data, and other services. A wireless communication between the UE 101b and the base station 102b in one or more wireless communication systems may be performed according to any suitable communication protocols, including, but not limited to, the 4G, the 5G, the future sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

The interaction sensing server 103 may be a network node which is configured to support the interaction sensing and related applications. For example, it may be a function entity of a core network. Both the sensing radar 102a and the UE 101b can communicate with the interaction sensing server 103, e.g., via wireless and/or wired channels. The sensing interaction server 103 may configure the sensing radar 102a and the UE 101b (for functions related to interaction sensing), receive and process sensing results from the sensing radar 102a and the UE 101b. In some embodiments, the sensing radar 102a and the UE 101b may register in the interaction sensing server 103 before their sensing operations.

A network 105 that interconnects the interaction sensing server 103, the sensing radar 102a and the base station 102b, may comprise a public switched telephone network (PSTN), an internet, and/or other networks.

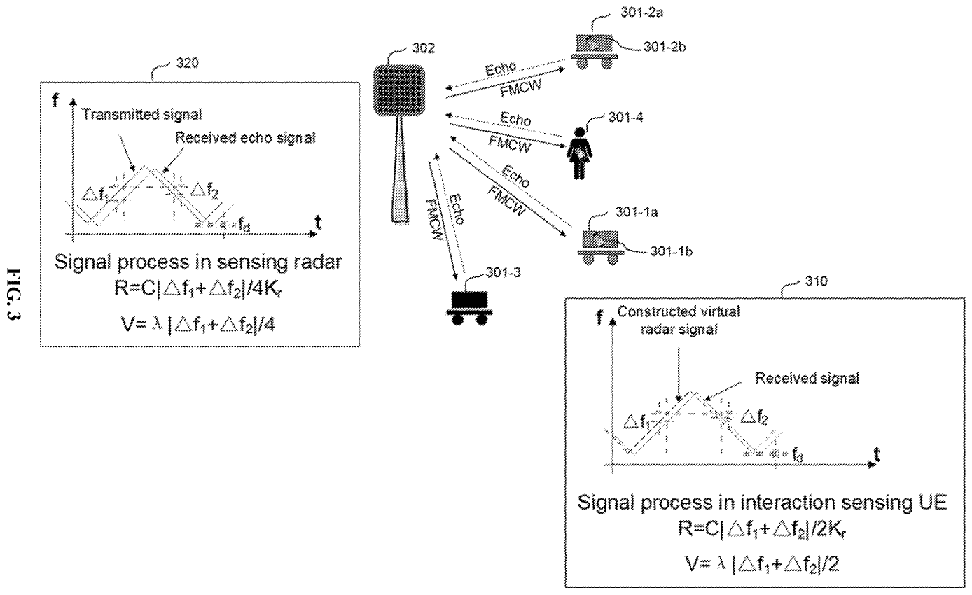

FIG. 2 illustrates another exemplary interaction sensing system 200 in which embodiments of the present disclosure can be implemented. The system 200 is an interaction sensing system with an integrated sensing radar. As shown in FIG. 2, a sensing radar 202a is integrated in a base station 202b, and they can be collectively referred to as BS sensing radar 202. The other entities of FIG. 2, such as the UE 201b carried on a movable object 201a and an interaction sensing server 203 may be implemented in a similar way as the corresponding entities 101a, 101b and 103 of the system 100.

A basic idea of the present disclosure is as following. A UE of a moving object can be configured by a sensing interaction server to sense or receive a sensing radar's signals for interaction sensing. For executing an interaction sensing, the UE may request the sensing interaction server to get the sensing radar's configuration information, e.g., the sensing radar's waveform (e.g., a type of the waveform (such as, frequency modulated continuous wave (FMCW), orthogonal frequency division multiplexing (OFDM), etc.), and related parameter), sensing time slot, frequency, beam direction, transmission power, etc. A sensing time slot is a time period during when a sensing radar is transmitting sensing signal plus a time period reserved for receiving echo signals. According to configuration information of the sensing radar, the UE may be capable to sense radar signals transmitted from the sensing radar, at each sensing time slot over a sensing frequency band.

The interaction sensing UE can receive a sensing radar signal, construct a corresponding virtual radar signal, and analyze waveforms of the received sensing radar signal and the constructed virtual radar signal to extract its own distance and velocity relative to the sensing radar. It should be noted that the virtual radar signal is not really transmitted by a UE or a sensing radar. The sensing UE only utilize radar configuration to generate the virtual radar signal. The constructed virtual radar signal could be used to emulate an actually transmitted radar signal, i.e., the radar signal actually transmitted from the radar. In some embodiments, the UE may measures signals strength of sensing radar signals and determine whether its owner (i.e., the moving object which is carrying the UE) is being sensed by the sensing radar. The UE's owner can be an AGV, a UAV, an autopilot vehicle, etc. For example, signal strength measurement can be utilized to determine whether the sensing radar is scanning its owner.

According to embodiments of the present disclosure, the UE can construct a virtual radar signal based on known information of the sensing radar, to emulate an actually transmitted sensing radar signal, which is then actually received by the UE. By comparing the virtual radar signal with its corresponding actual received radar signal, the UE can extract its own distance and velocity relative to the sensing radar.

FIG. 3 illustrates an exemplary scenario of interaction sensing, according to embodiments of the present disclosure. As an example, FIG. 3 uses a triangular FMCW signal to illuminate interaction sensing. A sensing radar 302 can transmit FMCW signals and receive echo signals, so as to sense the objects around it. Four moving objects are sensed by the sensing radar 302. AGV1 and AGV2 (denoted as 301-1a, 301-2a, respectively) have on-board UEs with interaction sensing ability (which can be referred to as interaction sensing UE hereinafter). AGV3 (also referenced 301-3) does not have UE. The pedestrian 301-4 has UE without interaction sensing ability. That is, the UE 301-1b of AGV1 and the UE 301-2b of AGV2 support interaction sensing according to embodiments of the present disclosure. Both UEs of AGV1 and AGV2 can make interaction sensing to sense radar signals from the radar 302.

As they know the configuration of the sensing radar 302, UE 301-1b and UE 301-2b can construct virtual radar signals to emulate original sensing radar FMCW signals transmitted by the sensing radar 302, and then compare the radar signals received at UE and the constructed virtual radar signals to calculate its distance and velocity relative to the sensing radar 302. In this example, UE 301-1b and UE 301-2b can use configuration information of the sensing radar 302 to construct the virtual radar signals which are the substantially same with (or similar as) the signals actually transmitted by the sensing radar 302. The virtual radar signals would have a same waveform (e.g., a triangular FMCW signal), a same timing and a same magnitude with the signals actually transmitted by the sensing radar 302. So, the constructed virtual radar signals could be used to emulate practical radar transmission signals, for extracting a velocity and distance at the UE side. Block 310 illustrates such signal process in an interaction sensing UE. In the graph, a received radar signal is shown as a full line, while a constructed virtual radar signal is shown as a dashed line. In an example, the distance and velocity can be calculated according to Doppler Effect. Here, R is distance between the sensing radar and a moving object. V is a velocity of a moving object relative to the sensing radar. C is a speed of light. Δf₁ is a frequency difference at a rising edge of radar signals. Δf₂ is a frequency difference at a falling edge of the radar signals. Kr is a frequency shift per unit of time. λ is a signal wavelength.

Meanwhile, the sensing radar 302 can also sense all of the four moving objects to calculate their distances and velocities relative to the sensing radar based on actual transmitted radar signals and echo signals received at the sensing radar 302. Block 320 illustrates a signal process in the sensing radar 302 for calculating a distance and velocity of one object relative to the sensing radar.

According to embodiments of the present disclosure, the interaction sensing UE sends to a network node (such as an interaction sensing server or other network nodes for interaction sensing), a report about information of its distance and velocity relative to the sensing radar. In the report, the interaction sensing UE may also indicate at which sensing time slot it extracts the distance and the velocity. Meanwhile, the sensing radar also sends to the network node (such as an interaction sensing server or other network nodes for interaction sensing), a report about distances and velocities of those sensed mobile objects relative to the sensing radar. Then, the network node makes a match operation to discriminate each interaction sensing UE and respective owner object. In this regard, the network node may try to match a particular interaction sensing UE with its owner (moving object), based on the reports of the sensing radar and the particular interaction sensing UE. For example, if a moving object sensed by the sensing radar at a sensing time slot has the similar distance and velocity with the sensing results of the particular interaction sensing UE, and the match is one to one correspondence, it can be determined that the moving object is the owner of the UE. Then, the network node can recognize the moving object. In this disclosure, the velocity of the UE relative to the sensing radar (estimated by an interaction sensing UE) and the velocity of a moving object relative to the sensing radar (calculated by the sensing radar) are radial velocities relative to the sensing radar. In this regard, a velocity would indicate a speed of a UE (or a moving object) relative to a sensing radar, and a radial direction of UE movement (or object movement) relative to the sensing radar. The radial direction indicates whether the UE (or object) is approaching or away from the radar radially. In this regard, this velocity may be also referred to as an instantaneous radial velocity relative to a radar.

The network node can uniquely identify the moving object via the particular UE and indicate it with the particular UE's identity information. The discrimination can make the interaction sensing server establish a communication relationship with those moving objects via their embedded interaction sensing UEs. In an example, the network node can provide a global moving objects map to the UEs for navigation, e.g., optimize path planning to avoid collision with other moving objects, or jointly plan paths for multiple mobile objects. The global moving objects map not only includes those identified moving objects via interaction sensing, but also includes those un-identified moving objects, e.g. a moving object without UE, or a moving object with UE but without interaction sensing ability.

Taking the scenario of FIG. 3 as an example, an interaction sensing server (not shown in FIG. 3) can recognize AGV1 and AGV2 by matching their velocities and distances sensed by the sensing radar 302 and respective interaction sensing UEs 301-1b, 301-2b. Then, the interaction sensing server can establish communication with them. The interaction sensing server can provide AGV1 and AGV2 a moving objects map for their navigation, e.g., by sending map data to UEs 301-1b, 301-2b or navigation systems thereon, respectively. The moving objects map may include all mobile objects'moving status (including the pedestrian 301-4, AGV1 301-1a, AGV2 301-2a and AGV3 301-3).

In embodiments of the present disclosure, an interaction sensing UE can precisely synchronize with a sensing radar. In an example, if sensing signals from a sensing radar carry some synchronization information, the interaction sensing UE can use that synchronization information to synchronize with the sensing radar.

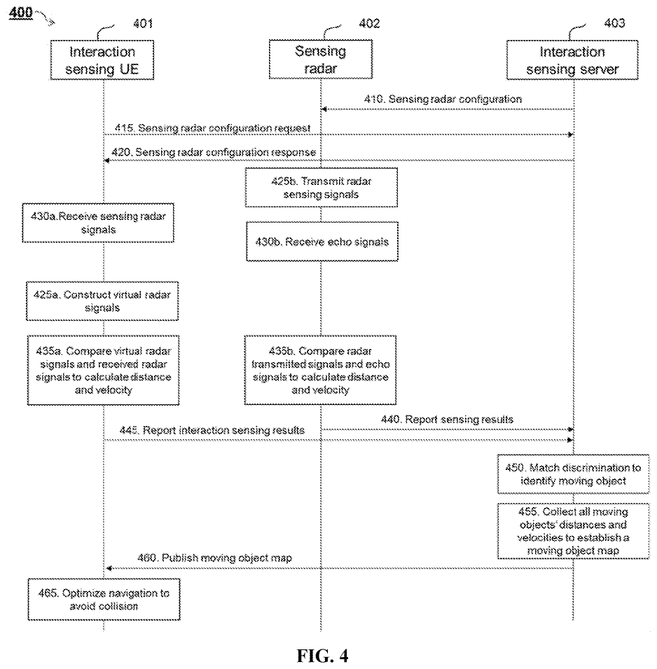

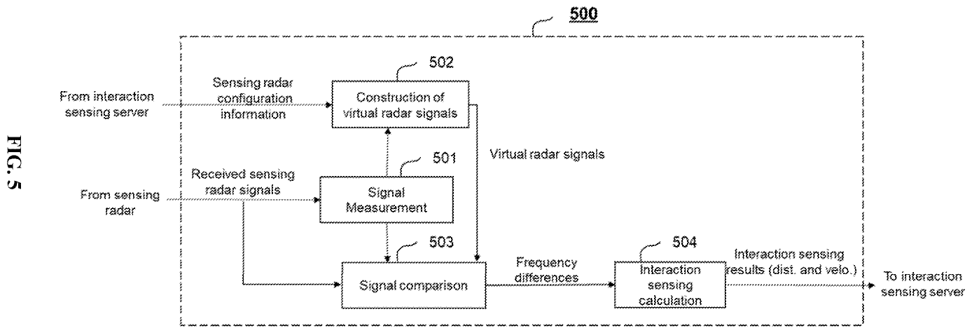

FIG. 4 illustrates an exemplary procedure 400 of interaction sensing operation, according to embodiments of the present disclosure. The procedure 400 involves an interaction sensing UE 401 (which is carried on or by an object, such as an AGV, UAV, autopilot vehicle, pedestrian, cyclist, vehicle, or the like), a sensing radar 402 and an interaction sensing server 403. The UE 401 may be implemented in a similar way as any of UE 101b, UE 201b, UE 301-1b, and UE 301-2b. The sensing radar 402 may be implemented in a similar way as any of the sensing radar 102a, 202a and 302. The interaction sensing server 403 may be implemented in a similar way as the interaction sensing server 103 or 203.

At step 410, the interaction sensing server 403 configures the sensing radar 402 to sense all those moving objects in its sensing scope. For example, the configuration information may include information of sensing waveform (such as FMCW, OFDM, etc.), information of sensing time slot (such as a size of sensing time slot, a period of sensing time slot, etc.), sensing subcarriers, sensing antenna, sensing signal transmission power, etc. Based on the configuration information, the sensing radar will transmit sensing radar signals, and sense moving objects in its sensing scope.

At step 415, when a moving object (such as an AGV, UAV, autopilot vehicle, pedestrian, cyclist, vehicle, or the like) with an interaction sensing UE comes into the sensing scope of the radar 402, the UE would request the interaction sensing server 403 to get configuration information of the sensing radar 402 for interaction sensing operations. In some embodiments, the UE 401 may be configured to determine that it enters a sensing scope of the radar 402. For example, the UE 401 may maintain a map of sensing scopes of one or more sensing radars, and then determine that it enters a sensing scope of the radar 402 according to the map and its own position. In another example, the UE 401 may be informed, for example by its access point, that it enters a sensing scope of the radar 402. The request may comprise any of an identity of the UE 401, a position of the UE 401, or an identity of the radar 401. In some embodiments, it may be due to the interaction sensing server 403 to determine that the UE 401 enters whose sensing scope, for example, based on the UE's position.

At step 420, in response to the request, the interaction sensing server 403 may send to the UE 401 configuration information of the sensing radar 402. In some embodiments, before responding with the configuration information, the interaction sensing server 403 may verify the UE 401 to check if it is an authorized UE, for example based on a UE's identity received from the request and a maintained profile related interaction sensing for the UE. If it is determined that the interaction sensing UE 401 is an authorized UE, then the configuration information can be sent to the UE 401.

At step 425b, the sensing radar 402 would transmit sensing radar signals at each sensing time slot as configured by the interaction sensing server 403 in step 410.

Meanwhile, at step 430a, the interaction sensing UE 401 would receive the sensing radar signals for interaction sensing at corresponding sensing time slots, for example, according to the received configuration information.

Meanwhile, at step 430b, the sensing radar 402 would receive an echo signal reflected from a moving object carrying the UE 401.

At step 425a, for each sensing time slot, the interaction sensing UE 401 would construct a virtual radar signal to emulate a sensing radar transmitted signal. The virtual radar signal is an emulation of the radar sensing signal actually transmitted by the sensing radar at step 425b, but it is not a really transmitted radar signal. It should be noted that the virtual radar signal is not really transmitted by the UE 401 or the sensing radar 402, and it is only generated in the UE 401 by using configuration information of the sensing radar 402. In this regard, a virtual radar signal corresponding to a sensing received radar signal for a particular sensing time slot, may be constructed based on configuration information of the sensing radar 402 and the particular sensing time slot.

At step 435a, for each sensing time slot, the interaction sensing UE 401 would compare constructed virtual radar signals with its received radar signals to estimate itself distance and velocity relative to the sensing radar 402. For example, the distance and velocity may be calculated as illustrated in block 310 of FIG. 3.

At step 435b, for each sensing time slot, the sensing radar 402 would compare a transmitted radar signal with a corresponding received echo signal to estimate the distance and the velocity of the moving object relative to the sensing radar 402. For example, the sensing radar 402 may make sensing calculation to obtain the moving object's distance and velocity, as illustrated in block 320 of FIG. 3.

At step 440, the sensing radar 402 reports its sensing results at each sensing time slot. In some examples, a plurality of objects would be sensed by the sensing radar 402 at one sensing time slot. Then sensing reports for a sensing time slot may comprise the distance and the velocity of each moving object of the plurality of objects sensed by the sensing radar 402 at the sensing time slot.

At step 445, the interaction sensing UE 401 also reports its interaction sensing results at each sensing time slot. The interaction sensing report for each sensing time slot may comprise an estimated distance and velocity of the UE for the sensing time slot.

Then, at step 450, based on reports of the interaction sensing UE 401 and the sensing radar 402 at each sensing time slot, the interaction sensing server 403 performs a matching between the UE 401 and an object. In this regard, the interaction sensing server 403 would find which moving object sensed by the radar 402 has a same distance and velocity with the estimated distance and velocity of the UE 401. The moving object with the same distance and velocity may be identified as the owner of the UE 401. For example, an identity of the UE 401 may be associated with the identity of the moving object. As such, the moving object would be recognized, and the interaction sensing server 403 would know who the moving object is.

At step 455, at each sensing time slot, the interaction sensing server 403 may collect sensing results of the sensing radar 402, and sensing results of other sensing radars (if any). These sensing results may be utilized by the interaction sensing server 403 to establish a moving objects map. In the map, those identified moving objects may be indicated with respective identities of their UEs. A position of the UE 401 may be indicated as the position of its owner object identified in step 450.

At step 460, the interaction sensing server 403 may publish the moving objects map to those recognized objects, by sending the map data to their UEs.

As an interaction sensing UE on a moving object (such as AGV, UAV, autopilot vehicle, pedestrian, cyclist, vehicle, or the like) knows its position in the moving object map, it can utilize the map to optimize navigation of the moving object, at step 465. For example, it can optimize a path of the moving object to avoid collision with other moving objects. Or both two recognized moving objects can be navigated to coordinately plan their paths to avoid collision.

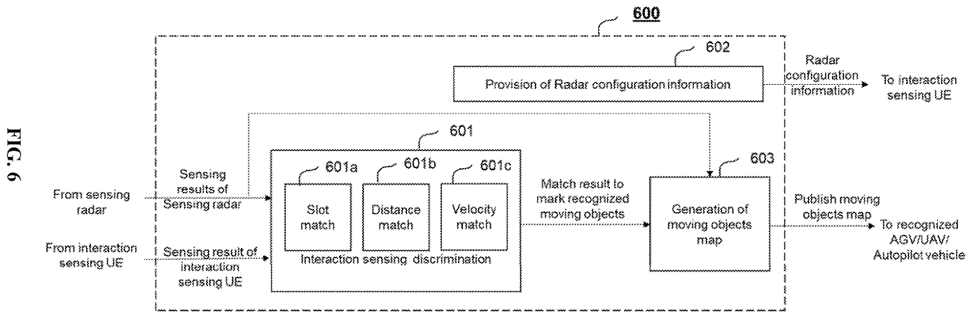

In some embodiments of the present disclosure, in order to implement interaction sensing, an interaction sensing UE may be provided with a new component or module, such as an interaction sensing component 500 as shown in FIG. 5. The UE may be any of UE 101b, UE 201b, UE 301-1b, UE 301-2b, and UE 401. The interaction sensing component 500 is configured to actively sense sensing radar signals and evaluate the UE's distance and velocity relative to a sensing radar. The interaction sensing component 500 comprises a signal measurement module 501, a signal construction module 502, a signal comparison module 503, and an interaction sensing calculation module 504.

At each sensing time slot, the signal measurement module 501 may measure signal strength of a received sensing radar signal at a sensing frequency band. If received signal strength (RSS) at a time slot is greater than a pre-defined threshold, it can be determined that the UE's owner (i.e., an object which is carrying the UE) is being scanned by the sensing radar at current time slot. Then, the interaction sensing UE will receive sensing radar signals. Meanwhile, the signal construction module 502 will be triggered to construct virtual radar signals to emulate the radar signals actually transmitted by the sensing radar, that can be compared with the actual received radar signals. In an example, when the UE detects sensing radar signals from a sensing radar, it may use known radar configuration information (such as waveform, timing, magnitude, etc.) of the sensing radar to construct the virtual radar signals.

The received sensing radar signals are inputted into the signal comparison module 503. Meanwhile, the corresponding virtual radar signals are also inputted into the signal comparison module 503. For each interaction sensing time slot, the received radar signals would be compared with corresponding constructed virtual radar signals. Frequency differences at different edges of a triangular pattern, such as the Δf₁ and Δf₂ depicted in FIG. 3, can be extracted by the signal comparison module 503 and input to the interaction sensing calculation module 504. There, the frequency differences would be used to calculate a distance and velocity of the UE as depicted in block 310 of FIG. 3. The calculation results (i.e., a distance and velocity of the UE relative to the sensing radar) may be sent to an interaction sensing server, so as to find an owner of the UE.

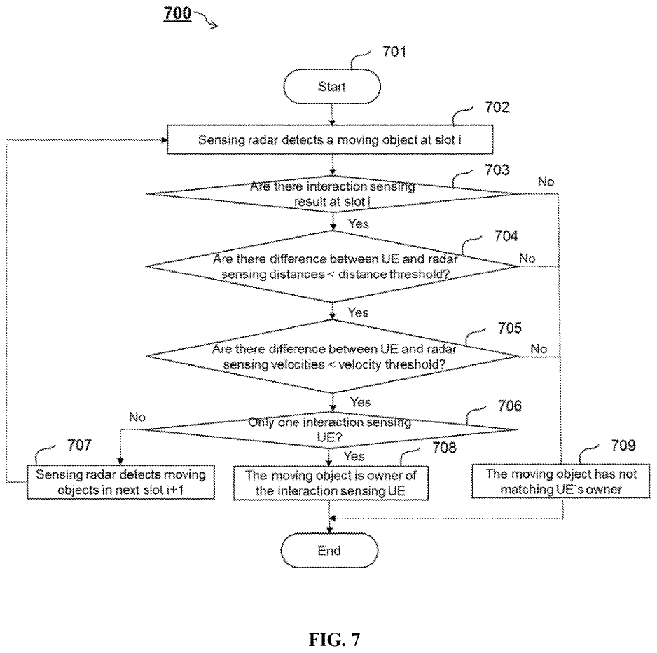

In order to support interaction sensing of some embodiments of the present disclosure, a network node for interaction sensing (such as a server or network function entity) may be provided with a new component or module, such as an interaction sensing component 600 as shown in FIG. 6. The network node may be any of the interaction sensing server 103, 203, or 403. The interaction sensing component 600 is configured to provide radar configuration information to an interaction sensing UE and match the UE with an object. The interaction sensing component 600 comprises an interaction sensing discrimination module 601. In some embodiments, the interaction sensing component 600 may optionally comprise a radar configuration information provision module 602 and/or a map generation module 603.

Inputs of the interaction sensing discrimination module 601 include an interaction sensing UE's sensing results and a sensing radar's sensing results. When a moving object (such as an AGV, UAV, autopilot vehicle, a pedestrian, a cyclist, a vehicle, or the like) comes into a sensing scope of the sensing radar, the sensing radar would sense this moving object. At the same time, the interaction sensing UE would sense radar signals transmitted from the sensing radar. The sensing radar can measure the moving object's distance and velocity relative the sensing radar, and the interaction sensing UE can measure its own distance and velocity relative the same sensing radar. These sensing results, together with information of a sensing time slot (based on radar signals in which sensing time slot the sensing results are derived) are provided to the interaction sensing discrimination module 601.

Based on these sensing results, the interaction sensing discrimination module 601 will discriminate whether a moving object is an owner of the interaction sensing UE. The discrimination procedure can be done over one sensing time slot, or over several sensing time slots if more than two moving objects are very close. The discrimination operation may include slot match, distance match and velocity match. Slot match (e.g., implemented in a submodule 601a) can guarantee that the sensing executed by the sensing radar and the measurement for received radar signals executed by the interaction sensing UE are performed at the same time. Distance match (e.g., implemented in a submodule 601b) and velocity match (e.g., implemented in a submodule 601c) can exclude other moving objects.

The interaction sensing discrimination module 601 may output match result to the map generation module 603. The map generation module 603 may utilize the match result to generate a moving objects map. Those recognized moving objects may be marked on the map. For example, an identity (ID) of a UE matched with a recognized moving object may be associated to the recognized moving object. Then, the moving objects map may be output or publish the moving objects map to recognized moving objects.

In some embodiments, the radar configuration information provision module 602 may provide configuration information of a sensing radar to an interaction sensing UE, for example, as illustrated in step 420 of FIG. 4.

During the discrimination procedure, if the sensing radar scans one moving object at a sensing time slot, only one interaction sensing UE senses the sensing radar signal at that sensing time slot, and they would have the similar velocity and distance relative to the sensing radar, then the moving object would be recognized as the owner of the UE. If the sensing radar senses a moving object at a sensing time slot, but no interaction sensing UE senses radar signals at that sensing time slot, or no sensing results of an interaction sensing UE has similar distance and velocity with that moving object, i.e., the moving object does not match with an interaction sensing UE, then the mobile object will not be recognized. If there is no one-to-one match, the discrimination procedure should be done over several sensing time slots until one-to-one match is established.

An exemplary discrimination procedure 700 is shown in FIG. 7. The discrimination procedure 700 starts at 701, and is performed for each sensing time slot. At step 702, from a sensing result of a sensing radar, it can be known that the sensing radar detects a moving object at a particular sensing time slot (denoted as slot i). Then, at step 703, a slot match can be executed. It can check if there is a sensing result of an interaction sensing UE for the particular sensing time slot i. If there is no such sensing result of an interaction sensing UE, it can be determined that the moving object does not match with any interaction sensing UE, as shown at step 709.

If there are one or more sensing results of interaction sensing UE, then a distance match can be executed. As shown at step 704, it can further check if there is a sensing result of interaction sensing UE which indicates a distance that differs from the distance indicated in the sensing radar's sensing result by less than a distance threshold. The distance threshold may be a predefined threshold. If there is no such sensing result of an interaction sensing UE, it can be determined that the moving object does not match with any interaction sensing UE, as shown at step 709.

At step 705, a velocity match can be executed. It can check if there is a sensing result of interaction sensing UE which indicates a velocity that differs from the velocity indicated in the sensing radar's sensing result by less than a velocity threshold. The velocity threshold may be a predefined threshold. If there is no such sensing result of an interaction sensing UE, it can be determined that the moving object does not match with any interaction sensing UE, as shown at step 709.

If only one interaction sensing UE passes the slot match, distance match and velocity match, at step 706, it can be determined that the moving object is matched with the UE, as shown at step 708. If more than one UE pass the slot match, distance match and velocity match, then the discrimination procedure 700 should be done over several sensing time slots until one-to-one match is established. For example, the procedure 700 may proceed to step 707, to check a sensing result of the sensing radar for a next sensing time slot (e.g., slot i+1), which continues to senses the moving object. Then, the procedure 700 may proceed to step 702, to perform a further slot match, distance match and velocity match for the sensing time slot i+1.

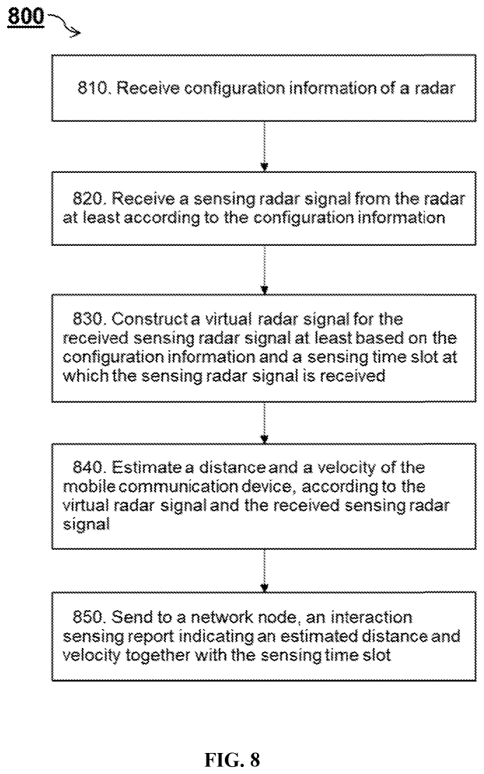

FIG. 8 is a flow chart depicting a method 800 according to embodiments of the present disclosure. The method 800 can be implemented at an interaction sensing UE, which may be any suitable mobile communication device. For example, the method 800 may be implemented at UE 101b, UE 201b, UE 301-1b, UE 301-2b, and UE 401. It can be appreciated that the method 800 may be implemented at other mobile communication devices.

As shown at block 810, the method 800 comprises receiving (e.g., by a UE), configuration information of a radar. The configuration information of the radar may be received from a network node, such as an interaction sensing server 103, 203, 403. The configuration information comprises at least one of the following: information about one or more waveforms of sensing radar signals to be transmitted from the radar, information about one or more sensing time slots at which the sensing radar signals are to be transmitted from the radar, information about one or more frequencies of the sensing radar signals to be transmitted from the radar, information about one or more beam directions of the sensing radar signals to be transmitted from the radar, and information about one or more transmission powers of the sensing radar signals to be transmitted from the radar.

In an embodiment, the UE may send a request for the configuration information of the radar to the network node (such as an interaction sensing server); and in response, receive the configuration information from the network node. The UE may determine that it enters a sensing scope of the radar; and thus send the request for the configuration information of the radar to the network node. The request may comprise at least one of the following: an identity of the mobile communication device, a position of the mobile communication device, or an identity of the radar.

As shown at block 820, the method 800 further comprises receiving a sensing radar signal from the radar at least according to the configuration information. In some embodiments, the method 800 may further comprise measuring a signal strength of the received sensing radar signal, and determining whether the object is sensed by the radar.

As shown at block 830, the method 800 further constructing a virtual radar signal for the received sensing radar signal at least based on the configuration information and a sensing time slot at which the sensing radar signal is received. The constructing of the virtual radar signal can be triggered by a determination that the object is sensed by the radar at the sensing time slot. In some embodiments, different sensing radar signals may be transmitted at different frequencies or bands in a same sensing time slot. Then, the virtual radar signal may be constructed further based on a frequency at which the received sensing radar signal is received.

As shown at block 840, the method 800 further comprises estimating a distance and a velocity of the mobile communication device, according to the virtual radar signal and the received sensing radar signal. Then, at block 850, the method 800 further comprises sending to the network node, an interaction sensing report indicating the estimated distance and velocity together with the sensing time slot for which the estimated distance and velocity is derived. In case the frequency of the received radar signal is utilized to construct the virtual radar signal, this frequency is also comprised in the interaction sensing report.

In some embodiments, an interaction sensing UE may receive more than one sensing radar signals from one same sensing radar at least according to the configuration information, for one sensing time slot. Some of these radar signals may be radar signals reflected from other objects. Then, the interaction sensing UE need to determine which of these radar signals is transmitted directly to the UE's object. For each of these radar signals, the UE can estimate a candidate distance and velocity of the mobile communication device, according to the virtual radar signal and the respective received radar signal; and determine a shortest distance among more than one estimated candidate distances. Since the reflected radar signals must experience a longer path than the direct radar signal, the shortest distance must correspond to the direct radar signal. Then, the shortest distance and corresponding velocity could be taken as the estimated distance and velocity of the mobile communication device, and reported to the network node.

In some embodiments, the method 800 may further comprise receiving from the network node, data of a moving object map which indicates positions of one or more moving objects. In the moving object map, a position of the mobile communication device is indicated as a position of the object. According to the map, the mobile communication device can control or navigate its matched object.

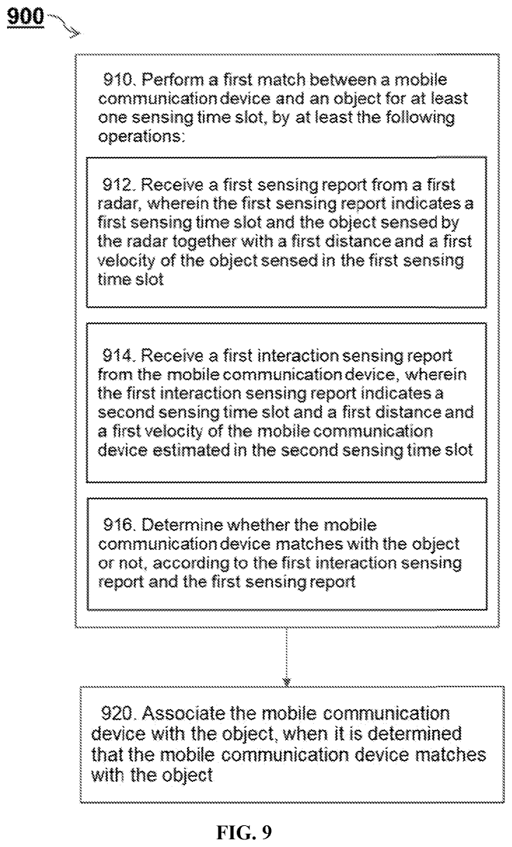

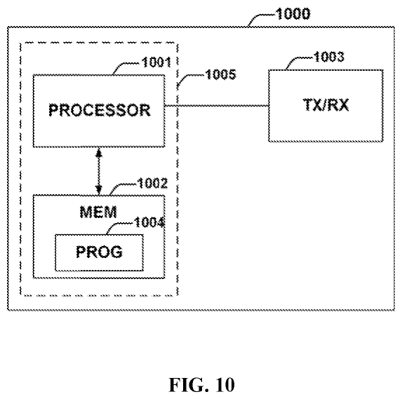

FIG. 9 is a flow chart depicting a method 900 according to embodiments of the present disclosure. The method 900 can be implemented at a network node or a network function entity, which may be any suitable communication device. For example, the method 900 may be implemented at the interaction sensing server 103, 203, and 403. It can be appreciated that the method 900 may be implemented at other network nodes or devices.

As shown at block 910, the method 900 comprises performing a first match between a mobile communication device (such as an interaction sensing UE) and an object (such as a moving object which is carrying the UE) for at least one sensing time slot. The first match comprises receiving a first sensing report from a first radar, wherein the first sensing report indicates a first sensing time slot and the object sensed by the radar together with a first distance and a first velocity of the object sensed in the first sensing time slot, as shown at block 912; receiving a first interaction sensing report from the mobile communication device, wherein the first interaction sensing report indicates a second sensing time slot and a first distance and a first velocity of the mobile communication device estimated in the second sensing time slot, as shown at block 914; and determining whether the mobile communication device matches with the object or not, according to the first interaction sensing report and the first sensing report, as shown at block 916.

As shown at block 920, the method 900 further comprises associating the mobile communication device with the object, when it is determined that the mobile communication device matches with the object.

In some embodiments, the method 900 may further comprise sending configuration information of the first radar to the mobile communication device. In an example, an interaction sensing server may receive a request for the configuration information of the first radar from the mobile communication device, and in response to a receipt of the request, send the configuration information to the mobile communication device. The request may comprise at least one of an identity of the mobile communication device, a position of the mobile communication device, or an identity of the first radar. The interaction sensing server may determine a sensing scope of which radar the mobile communication device enters into, according to the position of the mobile communication device.

In another example, an interaction sensing server may determine that the mobile communication device enters into a sensing scope of the first radar; and in response to a determination that the mobile communication device enters into the sensing scope of the first radar, send the configuration information to the mobile communication device. The interaction sensing server may receive from a base station (e.g., a base station which is serving the mobile communication device), an indication indicating that the mobile communication device enters into the sensing scope of the first radar. Alternatively, the interaction sensing server may receive from a base station (e.g., a base station which is serving the mobile communication device), a current position of the mobile communication device. The interaction sensing server may know a distribution of sensing spaces or scopes of respective sensing radars. Then, it can determine which radar scanning scope a mobile communication device has entered, at least according to the current position of the mobile communication device and the distribution of sensing spaces or scopes of respective sensing radars.

A base station may detect a position of a mobile communication device, and/or detect that a mobile communication device enters into a scanning scope of a radar, and then notify the interaction sensing server of the position of the mobile communication device and/or that the mobile communication device enters to into a scanning scope of a radar. In an example, when it is detected that a mobile communication device handovers into a cell of a current base station (e.g., a base station with the sensing radar function), e.g., by detecting a handover request from an adjacent base station for the mobile communication device and a handover acknowledgment (ACK) of the current base station, the current base station may know a position of the mobile communication device. For example, an identity (ID) of a cell into which the mobile communication device handovers indicates an approximate position of the mobile communication device. Alternatively or additionally, a mobile communication device may report its current position (e.g., GPS-based, time difference of arrival (TDOA)-based, cell ID-based, etc.) to its serving base station. Then, the base station may be able to determine whether a mobile communication device enters into a sensing scope of a radar, according to a current position of the mobile communication device and a distribution of sensing scopes of respective radars.

In some embodiments, determining whether the mobile communication device matches with the object may comprises: determining whether the second sensing time slot is same as the first sensing time slot or not; and in case that it is determined that the second sensing time slot is same as the first sensing time slot, comparing the first distance of the mobile communication device against the first distance of the object, and comparing the first velocity of the mobile communication device against the first velocity of the object. For example, it can be determined that the mobile communication device matches with the object, if a difference between the first distance of the mobile communication device and the first distance of the object is smaller than a first threshold, and a difference between the first velocity of the mobile communication device and the first velocity of the object is smaller than a second threshold.

In some embodiments, the first sensing report further indicates a first frequency of a sensing signal based on which the object is sensed, and the interaction sensing report further indicates a second frequency of a sensing signal based on which the first distance and velocity of the mobile communication device is estimated. Then, an interaction sensing server may determine whether the mobile communication device matches with the object by further determining whether the second frequency is same as the first frequency or not.

In some embodiments, the method 900 may further comprise determining whether the mobile communication device is a sole mobile communication device which matches with the object or not; and in case that it is determined that the mobile communication device is not the only mobile communication device which matches with the object, performing further matches between the mobile communication device and the object for one or more subsequent sensing time slots. The method 900 may further comprise associating the mobile communication device with an object, when the mobile communication device is the sole mobile communication device which matches with the object. For example, an identity of the mobile communication device can be associated with an identity of the object.

In some embodiments, the method 900 may further comprise establishing a moving object map which indicates positions of one or more moving objects. A position of the mobile communication device would be indicated in the map as a position of the object. Then, the moving object map may be sent to one or more mobile communication devices.

In some embodiments, the interaction sensing report further indicates a position of the mobile communication device relative to the radar in a three dimensions (3D) space. For example, an angle of the mobile communication device relative to the radar can be also derived from the received radar signal, and then comprised in the interaction sensing report. The position in the 3D space may be determined based on the angle and the estimated distance according to a system of polar coordinates. This further information may extend embodiments of the present disclosure to a three dimension (3D), and potential applications, for example in identifying identically looking drones in a swarm during a formation flight. In a 3D case, a sensing radar is able to scan in all spherical directions, and the interaction sensing UE is able to sense a direction of the incoming radar signal in every direction. For example, those spherical radars exist in aviation. Alternatively, the scan in all spherical directions can be implemented by a rotating single beam or by a beamformed 3D antenna array, or a rotating 2D antenna array for which the rotation gives the third dimension.

In some embodiments, a direction of a velocity of a UE and an object relative to the sensing radar, and/or a tangential velocity of a UE and an object relative to the radar, may be detected and reported to an interaction sensing server. The radar signal's Doppler shift provides only a radial velocity of an object. Then, a tangential velocity can be estimated from multiple measurements over slightly different directions. The matching process requires the velocities to be expressed in the same coordinate system. The UE may not know its motion in the global (Earth) coordinate system but only in its local coordinate system, so the expression of its own global velocity is not trivial. However, it can express its own velocity direction relative to a radar incidence angle of the received sensing radar signal (assuming that it knows how its own antenna is oriented on the body), and it can derive a relative angle of the UE relative to the radar, e.g., based on angle-of-arrival positioning technology. If the UE's own antenna configuration is not known, the UE can make multiple measurements over multiple sensing time slots to determine its own position relative to the radar at multiple points and then calculate its own velocity from the difference of those points. The radar can sense a velocity direction of an object in global coordinates, but it can easily convert it to an angle relative to the radar beam direction. These relative angles need to be matched for a UE and the radar. Thus, an interaction sensing server may determine whether the UE matches with the object by further comparing respective relative angle of velocities or tangential velocities indicated in the UE's sensing report and the radar's sensing report.

If the UEs are able to perform self-localization by other means (for example, visual-inertial odometry, real-time kinematic (RTK)-global position system (GPS), etc.), then they can also share that information, e.g., as “payment” for accessing the global map (which is useful for them as it also contains the objects out of their own sensing range). Thus, in some embodiments, the UE's sensing report may further indicate a position of the interaction sensing UE.

In some scenarios, multiple UEs may line up in a radial direction relative to a sensing radar. In this case, the one UE closest to the radar may shadow out the others. This case needs to be handled by a second sensing radar, which can sense the objects from a different viewpoint. The positions of the radars are known, and the two radars can communicate with each other via an interaction sensing server. The server can coordinate that neighboring radars operate in disjoint sensing time slots and/or disjoint frequencies. When two or more radars sense the UE(s), their information can be merged into a more confident 3D map (constructed in the server).

In this case, the method 900 may further comprise performing a second match between the mobile communication device and the object for at least one sensing time slot; determine whether the mobile communication device matches with the object or not, based on the first match and the second match; and associating the mobile communication device with the object, when it is determined that the mobile communication device matches with the object based on the first match and the second match. The second match may be performed by receiving a second sensing report from a second radar, wherein the second sensing report indicates a third sensing time slot and the object sensed by the second radar together with a second distance and a second velocity of the object sensed in the third sensing time slot; receiving a second interaction sensing report from the mobile communication device, wherein the second interaction sensing report indicates a fourth sensing time slot and a second distance and a second velocity of the mobile communication device estimated in the fourth sensing time slot; and determining whether the mobile communication device matches with the object or not, according to the second interaction sensing report and the second another sensing report.

Some embodiments provide a system where everyone is cooperative and their joint goal is to determine the best possible map of the world. There are fix BS sensing radars (whose global positions and orientations may be known to interaction sensing server) that sense the moving objects via radar, and there are autonomous agents, that are able to localize themselves by some means (such as various sorts of simultaneous localization and mapping (SLAM), wheel odometry, etc.). For example, some autonomous agents (moving objects) may carry an interaction sensing UE and may be communicatively coupled with it. The autonomous localization functions may include some on-board sensors and corresponding software. Interaction sensing UE can also collect position information from these autonomous localization functions, and report to interaction sensing server, together with its interaction sensing results. The interaction sensing server could utilize these extra pose (position and orientation) information in establishing a moving object map. As the interaction sensing server has associated UE with a moving object sensed by a radar (which provides a global coordinate), it can make some coordinate transform, i.e., from a local coordinate to a global coordinate, and then add those extra pose information into the map. In this regard, if the autonomous agents are able to perform global localization (for example via RTK-GPS), they could share that information with the interaction sensing server who could utilize these information directly into a moving object map. However, if the autonomous agents can only localize themselves in a local coordinate system (like most techniques, for example via 2D Lidar, via visual SLAM, via wheel odometry, etc.), they could share their relative movements with the system plus their measurements of radar sensing signals, which could be used to determine their global position. Essentially, a radar would act as a fix landmark (or “beacon”) in the world that can be used by the sever to align each agent's local coordinate system (which can be different for each autonomous agent) with the world.

Now reference is made to FIG. 10 illustrating a simplified block diagram of an apparatus 1000 that may be embodied in/as a mobile communication device (such as an interaction sensing UE), or a network node (such as an inaction sensing server). The apparatus 1000 may comprise at least one processor 1001, such as a data processor (DP) and at least one memory (MEM) 1002 coupled to the at least one processor 1001. The apparatus 1000 may further comprise one or more transmitters TX, one or more receivers RX 1003, or one or more transceivers coupled to the one or more processors 1001 to communicate wirelessly and/or through wireline.

Although not shown, the apparatus 1000 may have at least one communication interface, for example, the communicate interface can be at least one antenna, or transceiver as shown in the FIG. 10. The communication interface may represent any interface that is necessary for communication with other network entities.

The processors 1001 may be of any type suitable to the local technical environment, and may include one or more of the following: general purpose computers, special purpose computers, microprocessors, digital signal processors (DSPs) and processors based on multicore processor architecture, as non-limiting examples.

The MEMs 1002 may be of any type suitable to the local technical environment and may be implemented using any suitable data storage technology, such as semiconductor-based memory devices, magnetic memory devices and systems, optical memory devices and systems, fixed memory and removable memory, as non-limiting examples.

The MEM 1002 stores a program (PROG) 1004. The PROG 1004 may include instructions that, when executed on the associated processor 1001, enable the apparatus 1000 to operate in accordance with the embodiments of the present disclosure, for example to perform one of the methods 800 and 900. A combination of the at least one processor 1001 and the at least one MEM 1002 may form processing circuitry or means 1005 adapted to implement various embodiments of the present disclosure.

Various embodiments of the present disclosure may be implemented by computer program executable by one or more of the processors 1001, software, firmware, hardware or in a combination thereof.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosures may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosures may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium, for example, non-transitory computer readable medium, such as a hard disk, optical disk, removable storage media, solid state memory, RAM, etc. As will be appreciated by one of skills in the art, the function of the program modules may be combined or distributed as desired in various embodiments. In addition, the function may be embodied in whole or in part in firmware or hardware equivalents such as integrated circuits, field programmable gate arrays (FPGA), and the like.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1-49. (canceled)

50. An apparatus at a mobile communication device which is carried on an object, the apparatus comprising:
at least one processor; and
at least one memory storing instructions that, when executed by the at least one processor, cause the apparatus at least to:
receive configuration information of a radar;
receive a sensing radar signal from the radar at least according to the configuration information;
construct a virtual radar signal for the received sensing radar signal at least based on the configuration information and a sensing time slot at which the sensing radar signal is received;
estimate a distance and a velocity of the mobile communication device, according to the virtual radar signal and the received sensing radar signal; and
send to a network node, an interaction sensing report indicating an estimated distance and velocity together with the sensing time slot.

51. The apparatus according to claim 50, wherein the configuration information of the radar is received from the network node.

52. The apparatus according to claim 50, wherein the instructions, when executed by the one or more processors, further cause the apparatus at least to:
send a request for the configuration information of the radar to the network node; and
receive the configuration information from the network node.

53. The apparatus according to claim 50, wherein the instructions, when executed by the at least one processor, further cause the apparatus at least to:
determine that the object is sensed by the radar at the sensing time slot; and
in response to a determination that the mobile object is sensed by the radar at the sensing time slot, construct the virtual radar signal.

54. The apparatus according to claim 50, wherein the configuration information comprises at least one of the following:
information about one or more waveforms of sensing radar signals to be transmitted from the radar,
information about one or more sensing time slots at which the sensing radar signals are to be transmitted from the radar,
information about one or more frequencies of the sensing radar signals to be transmitted from the radar,
information about one or more beam directions of the sensing radar signals to be transmitted from the radar, and
information about one or more transmission powers of the sensing radar signals to be transmitted from the radar.

55. The apparatus according to claim 50, wherein the virtual radar signal is constructed further based on a frequency at which the received sensing radar signal is received.

56. The apparatus according to claim 50, wherein the interaction sensing report further indicates at least one of the following:
an angle of the mobile communication device relative to the radar,
a position of the mobile communication device,
a direction of the velocity relative to the radar,
a radial velocity of the mobile communication device relative to the radar, or
a tangential velocity of the mobile communication device relative to the radar.

57. The apparatus according to claim 50, wherein the instructions, when executed by the at least one processor, further cause the apparatus at least to:
receive more than one sensing radar signals from the sensing radar at least according to the configuration information;
for each received sensing radar signal of the more than one sensing radar signals, estimate a candidate distance and velocity of the mobile communication device, according to the virtual radar signal and the respective received sensing radar signal;
determine a shortest distance among more than one estimated candidate distances; and
take the shortest distance and corresponding velocity as the estimated distance and velocity of the mobile communication device.

58. The apparatus according to claim 50, wherein the instructions, when executed by the at least one processor, further cause the apparatus at least to:
receive from the network node, data of a moving object map which indicates positions of one or more moving objects.

59. The apparatus according to claim 50, wherein the object is one of the following:
automated guided vehicle (AGV),
unmanned aerial vehicle (UAV),
autopilot vehicle,
pedestrian,
cyclist, or
vehicle.

60. An apparatus at a network node, the apparatus comprising:
at least one processor; and
at least one memory storing instructions that, when executed by the at least one processor, cause the apparatus at least to:
perform a first match between a mobile communication device and an object for at least one sensing time slot, by at least the following operations:
receiving a first sensing report from a first radar, wherein the first sensing report indicates a first sensing time slot and the object sensed by the first radar together with a first distance and a first velocity of the object sensed in the first sensing time slot;
receiving a first interaction sensing report from the mobile communication device, wherein the first interaction sensing report indicates a second sensing time slot and a first distance and a first velocity of the mobile communication device estimated in the second sensing time slot; and
determining whether the mobile communication device matches with the object or not, according to the first interaction sensing report and the first sensing report; and
associate the mobile communication device with the object, when it is determined that the mobile communication device matches with the object.

61. The apparatus according to claim 60, wherein the instructions, when executed by the at least one processor, further cause the apparatus at least to:
send configuration information of the first radar to the mobile communication device.

62. The apparatus according to claim 60, wherein the instructions, when executed by the at least one processor, further cause the apparatus at least to:
receive a request for the configuration information of the first radar from the mobile communication device; and
in response to the request, send the configuration information to the mobile communication device.

63. The apparatus according to claim 60, wherein the instructions, when executed by the at least one processor, further cause the apparatus at least to determine whether the mobile communication device matches with the object by:
determining whether the second sensing time slot is same as the first sensing time slot or not; and
in case that it is determined that the second sensing time slot is same as the first sensing time slot, comparing the first distance of the mobile communication device against the first distance of the object, and comparing the first velocity of the mobile communication device against the first velocity of the object.

64. The apparatus according to claim 63, wherein the instructions, when executed by the at least one processor, further cause the apparatus at least to determine whether the mobile communication device matches with the object by:
determining that the mobile communication device matches with the object, if a difference between the first distance of the mobile communication device and the first distance of the object is smaller than a first threshold, and a difference between the first velocity of the mobile communication device and the first velocity of the object is smaller than a second threshold.

65. The apparatus according to claim 60, wherein the interaction sensing report further indicates at least one of the following:
an angle of the mobile communication device relative to the first radar,
a position of the mobile communication device,
a direction of the first velocity of the mobile communication device relative to the first radar;
a radial velocity of the mobile communication device relative to the first radar, or
a tangential velocity of the mobile communication device relative to the first radar.

66. The apparatus according to claim 60, wherein the instructions, when executed by the at least one processor, further cause the apparatus at least to associate the mobile communication device with the object by:
associating an identity of the mobile communication device with an identity of the object.

67. The apparatus according to claim 60, wherein the instructions, when executed by the at least one processor, further cause the apparatus at least to perform at least one of the following operations via the mobile communication device:
communicating with the object;
identifying the object; or
controlling the object.

68. The apparatus according to claim 60, wherein the instructions, when executed by the at least one processor, further cause the apparatus at least to:
establish a moving object map which indicates positions of one or more moving objects, wherein a position of the mobile communication device is indicated in the map as a position of the object.

69. A method performed at a mobile communication device which is carried on an object, the method comprising:
receiving configuration information of a radar;
receiving a sensing radar signal from the radar at least according to the configuration information;
constructing a virtual radar signal for the received sensing radar signal at least based on the configuration information and a sensing time slot at which the sensing radar signal is received;
estimating a distance and velocity of the mobile communication device, according to the virtual radar signal and the received sensing radar signal; and
sending to a network node, an interaction sensing report indicating the estimated distance and velocity together with the sensing time slot.
